(19) United States
(12) Patent Application Publication
(10) Pub. No.: US 2020/0357141 A1
(43) Pub. Date: Nov. 12, 2020

(54) SYSTEMS AND METHODS FOR CALIBRATING AN OPTICAL SYSTEM OF A MOVABLE OBJECT

(71) Applicant: SZ DJI TECHNOLOGY CO., LTD., Shenzhen (CN)

(72) Inventors: You ZHOU, Shenzhen (CN); Jianzhao CAI, Shenzhen (CN); Bin XU, Shenzhen (CN)

(21) Appl. No.: 16/937,047

(22) Filed: Jul. 23, 2020

Related U.S. Application Data
(63) Continuation of application No. PCT/CN2018/073866, filed on Jan. 23, 2018.

(51) Int. Cl. G06T 7/80; G06T 7/73; G06T 7/593; H04N 13/239; H04N 13/246

(52) U.S. Cl. CPC G06T 7/85; G06T 7/74; G06T 7/593; G06T 2207/10032; H04N 13/246; G06T 2207/30244; H04N 13/239

(57) ABSTRACT

A method of calibrating an imaging system may includes capturing images using at least one imaging device, identifying feature points in the images, identifying calibration points from among the feature points, and determining a posture of the at least one imaging device or a different imaging device based on positions of the calibration points in the images.

### CROSS-REFERENCE TO RELATED APPLICATION

This application is a continuation of International Application No. PCT/CN2018/073866, filed Jan. 23, 2018, the entire content of which is incorporated herein by reference.

### TECHNICAL FIELD

The present disclosure relates generally to systems and methods for calibrating an optical system and, more particularly, to systems and methods for calibrating an optical system on a movable object, such as an unmanned aerial vehicle.

### BACKGROUND

In the fields of computer vision and machine vision, information about objects in three-dimensional space may be collected using imaging equipment, including one or more digital cameras. The collected information, which may be in the form of digital images or digital videos (“image data”), may then be analyzed to identify objects in the images or videos and determine their locations in two-dimensional or three-dimensional coordinate systems. The image data and determined locations of the identified objects may then be used by humans or computerized control systems for controlling devices or machinery to accomplish various scientific, industrial, artistic, or leisurely activities. The image data and determined locations of the identified objects may also or alternatively be used in conjunction with image processing or modeling techniques to generate new images or models of the scene captured in the image data and/or to track objects in the images.

In some situations, the imaging equipment can become misaligned with respect to a calibration position, which can adversely affect image analysis and processing, feature tracking, and or other functions of the imaging system. For example, during operation, imaging systems can sustain physical impacts, undergo thermal expansion or contraction, and/or experience other disturbances resulting in changes to the physical posture of one or more imaging devices associated with the system. Thus, the imaging system must be periodically recalibrated to restore accuracy of its functions.

While the effects of misalignment can be experienced by any single camera in an imaging system, this problem can also have particular effects on multi-camera systems, such as stereo imaging systems. Stereo imagery is one technique used in the fields of computer vision and machine vision to view or understand the location of an object in three-dimensional space. In stereo imagery, multiple two-dimensional images are captured using one or more imaging devices (such as digital cameras or video cameras), and data from the images are manipulated using mathematical algorithms and models to generate three-dimensional data and images. This method often requires an understanding of the relative physical posture of the multiple imaging devices (e.g., their translational and/or rotational displacements with respect to each other), which may require the system to be periodically calibrated when the posture of one or more imaging devices changes.

Known calibration techniques are labor intensive, complex, and require the digital imaging system to be taken out of service. For example, some calibration techniques require multiple images to be taken of specialized patterns projected on a screen or plate from multiple different angles and locations. This requires the digital imaging system to be taken out of service and brought to a location where these calibration aids can be properly used. Furthermore, the position of the digital imaging system during calibration (e.g., the angles and distances of the imaging devices with respect to the specialized patterns) must be carefully set by the calibrating technician. Thus, if any of the calibration configurations are inaccurate, the calibration may not be effective and must be performed again.

There is a need for improved systems and methods for calibrating optical systems, such as digital imaging systems on movable objects, to effectively and efficiently overcome the above-mentioned problems.

### SUMMARY

In one embodiment, the present disclosure relates to a method of calibrating an imaging system. The method may include capturing images using at least one imaging device, identifying feature points in the images, identifying calibration points from among the feature points, and determining the posture of the at least one imaging device or a different imaging device based on the positions of the calibration points in the images.

In another embodiment, the present disclosure relates to a system for calibrating a digital imaging system. The system may include a memory having instructions stored therein, and an electronic control unit having a processor configured to execute the instructions. The electronic control unit may be configured to execute the instructions to capture images using at least one imaging device, identify feature points in the images, identify calibration points from among the feature points, and determine a posture of the at least one imaging device or a different imaging device based on positions of the calibration points in the images.

In yet another embodiment, the present disclosure relates to a non-transitory computer-readable medium storing instructions, that, when executed, cause a computer to perform a method of calibrating a imaging system. The method may include capturing images using at least one imaging device, identifying feature points in the images, identifying calibration points from among the feature points, and determining a posture of the at least one imaging device or a different imaging device based on positions of the calibration points in the images.

In yet another embodiment, the present disclosure relates to an unmanned aerial vehicle (UAV). The UAV may include a propulsion device, an imaging device, a memory storing instructions; and an electronic control unit in communication with the propulsion device, and the memory. The controller may include a processor configured to execute the instructions to capture images using at least one imaging device, identify feature points in the images, identify calibration points from among the feature points, and determine a posture of the at least one imaging device or a different imaging device based on positions of the calibration points in the images.

### BRIEF DESCRIPTION OF THE DRAWINGS

FIG. 1 is a perspective view of an exemplary movable object consistent with embodiments of this disclosure;

FIG. 2 is a schematic illustration of an exemplary control system consistent with embodiments of this disclosure;

FIG. 3 is a schematic illustration of an exemplary movable object in a three-dimensional environment, consistent with embodiments of this disclosure;

FIG. 4 is an illustration of an exemplary image and two-dimensional coordinate system consistent with embodiments of this disclosure;

FIG. 5 is a block diagram showing an exemplary method consistent with embodiments of this disclosure;

FIG. 6 is a is an illustration of two exemplary images consistent with embodiments of this disclosure;

FIG. 7 is an illustration showing disparity between two exemplary images consistent with embodiments of this disclosure;

FIG. 8 is an illustration of an exemplary set of images consistent with embodiments of this disclosure; and

FIG. 9 is an illustration of an exemplary image demonstrating an angular offset between two exemplary coordinate systems, consistent with embodiments of this disclosure.

### DETAILED DESCRIPTION

The following detailed descriptions refer to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

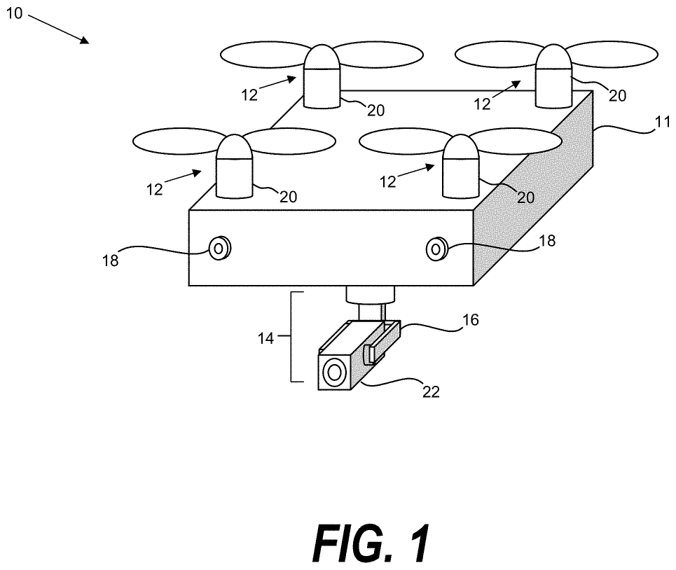

FIG. 1 shows an exemplary movable object 10 that may be configured to move within an environment. As used herein, the term “movable object” (e.g., movable object 10) may include an object, device, mechanism, system, or machine configured to travel on or within a suitable medium (e.g., a surface, air, water, one or more rails, space, underground, etc.). For example, movable object 10 may be an unmanned aerial vehicle (UAV). Although movable object 10 is shown and described herein as a UAV for exemplary purposes of this description, it is understood that other types of movable objects (e.g., wheeled objects, nautical objects, locomotive objects, other aerial objects, etc.). may also or alternatively be used in embodiments consistent with this disclosure. As used herein, the term “UAV” may refer to an aerial device configured to be operated and/or controlled automatically (e.g., via an electronic control system) and/or manually by off-board personnel.

Movable object 10 may include a housing 11, one or more propulsion assemblies 12, and a payload 14, such as a camera or video system. In some embodiments, as shown in FIG. 1, payload 14 may be connected or attached to movable object 10 by a carrier 16, which may allow for one or more degrees of relative movement between payload 14 and movable object 10. In other embodiments, payload 14 may be mounted directly to movable object 10 without carrier 16. Movable object 10 may also include one or more imaging devices 18 attached to housing 11 (or to another component of movable object 10).

Propulsion assemblies 12 may be positioned at various locations (for example, top, sides, front, rear, and/or bottom of movable object 10) for propelling and steering movable object 10. Although only four exemplary propulsion assemblies 12 are shown in FIG. 1, it will be appreciated that movable object 10 may include any number of propulsion assemblies (e.g., 1, 2, 3, 4, 5, 10, 15, 20, etc.). Propulsion assemblies 12 may be devices or systems operable to generate forces for sustaining controlled flight. Each propulsion assembly 12 may also include one or more power sources 20, e.g., an electric motor, engine, or turbine configured to participate in the generation of forces for sustaining controlled flight. Power sources 20 may include or be connected to a fuel source or energy source, such as one or more batteries, fuel cells, solar cells, fuel reservoirs, etc., or combinations thereof. Each power source 20 may be connected to a rotary component for generating lift or thrust forces, such as a rotor, propeller, blade, etc., which may be driven on or by a shaft, axle, wheel, or other component or system configured to transfer power to the rotary component from the power source. Propulsion assemblies 12 and/or power sources 20 may be adjustable (e.g., tiltable) with respect to each other and/or with respect to movable object 10. Alternatively, propulsion assemblies 12 and power sources 20 may have a fixed orientation with respect to each other and/or movable object 10. In some embodiments, each propulsion assembly 12 may be of the same type. In other embodiments, propulsion assemblies 12 may be of multiple different types. In some embodiments, all propulsion assemblies 12 may be controlled in concert (e.g., all at the same speed and/or angle). In other embodiments, one or more propulsion devices may be independently controlled with respect to, e.g., speed and/or angle.

Propulsion assemblies 12 may be configured to propel movable object 10 in one or more vertical and horizontal directions and to allow movable object 10 to rotate about one or more axes. That is, propulsion assemblies 12 may be configured to provide lift and/or thrust for creating and maintaining translational and rotational movements of movable object 10. For instance, propulsion assemblies 12 may be configured to enable movable object 10 to achieve and maintain desired altitudes, provide thrust for movement in all directions, and provide for steering of movable object 10. In some embodiments, propulsion assemblies 12 may enable movable object 10 to perform vertical takeoffs and landings (i.e., takeoff and landing without horizontal thrust). In other embodiments, movable object 10 may require constant minimum horizontal thrust to achieve and sustain flight. Propulsion assemblies 12 may be configured to enable movement of movable object 10 along and/or about multiple axes.

Payload 14 may include at least one sensory device 22, such as the exemplary sensory device 22 shown in FIG. 1. Sensory device 22 may include a device for collecting or generating data or information, such as surveying, tracking, and capturing images or video of targets (e.g., objects, landscapes, subjects of photo or video shoots, etc.). Sensory device 22 may include an imaging device configured to gather data that may be used to generate images. For example, imaging devices may include imaging devices (e.g., analog or digital photographic cameras, binocular cameras, video cameras, etc.), infrared imaging devices, ultraviolet imaging devices, x-ray devices, ultrasonic imaging devices, radar devices, etc. Sensory device 22 may also or alternatively include devices for capturing audio data, such as microphones or ultrasound detectors. Sensory device 22 may also or alternatively include other suitable sensors for capturing visual, audio, and/or electromagnetic signals. Although sensory device 22 is shown and described herein as an imaging device for exemplary purposes of this description (and may also be referred to as imaging device 22), it is understood that other types of sensory devices may be used, such as those mentioned above.

Carrier 16 may include one or more devices configured to hold the payload 14 and/or allow the payload 14 to be adjusted (e.g., rotated) with respect to movable object 10. For example, carrier 16 may be a gimbal. Carrier 16 may be configured to allow payload 14 to be rotated about one or more axes, as described below. In some embodiments, carrier 16 may be configured to allow 360° of rotation about each axis to allow for greater control of the perspective of the payload 14. In other embodiments, carrier 16 may limit the range of rotation of payload 14 to less than 360° (e.g., ≤270°, ≤210°, ≤180, ≤120°, ≤90°, ≤45°, ≤30°, ≤15° etc.), about one or more of its axes.

Imaging devices 18 and 22 may include devices capable of capturing image data. For example, imaging devices 18 and 22 may include digital photographic cameras (“digital cameras”), digital video cameras, or digital cameras capable of capturing still photographic image data (e.g., still images) and video image data (e.g., video streams, moving visual media, etc.). Imaging devices 18 may be fixed such that their fields of view are non-adjustable, or alternatively may be configured to be adjustable with respect to housing 11 so as to have adjustable fields of view. Imaging device 22 may be adjustable via carrier 16 or may alternatively be fixed directly to housing 11 (or a different component of movable object 10). Imaging devices 18 and 22 may have known focal length values (e.g., fixed or adjustable for zooming capability), distortion parameters, and scale factors, which also may be determined empirically through known methods. Imaging devices 18 may be separated by a fixed distance (which may be known as a “baseline”), which may be a known value or determined empirically.

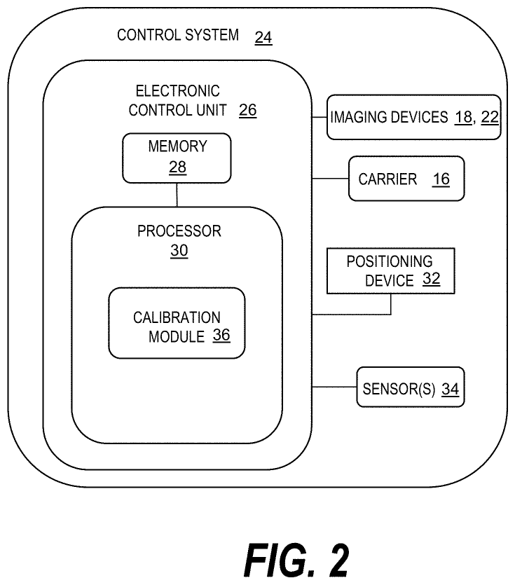

Movable object 10 may also include a control system for controlling various functions of movable object 10 and its components. FIG. 2 is a schematic block diagram of an exemplary control system 24 that may be included on, connected to, or otherwise associated with movable object 10. Control system 24 may include an electronic control unit 26, which may include a memory 28 and a processor 30. Electronic control unit 26 may be in electronic communication with other components of movable object 10, such as imaging devices 18 and 22, carrier 16, and other devices, such as a positioning device 32 and/or one or more sensors 34. Control system 24 may support and/or control the functions of imaging devices 18 and 22 as well as the processing of image data collected by imaging devices 18 and 22. Image processing may include analyzing, manipulating, and performing mathematical operations using image data. Control system 24 in conjunction with imaging devices 18 and 22 may therefore be referred to as an imaging system.

Electronic control unit 26 may be a commercially available or proprietary electronic control unit that includes data storage and processing capabilities. For example, electronic control unit may include memory 28 and processor 30. In some embodiments, electronic control unit 26 may comprise memory and a processor packaged together as a unit or included as separate components.

Memory 28 may be or include non-transitory computer-readable media and can include one or more memory units of non-transitory computer-readable media. Non-transitory computer-readable media of memory 36 may be or include any type of disk including floppy disks, hard disks, optical discs, DVDs, CD-ROMs, microdrive, magneto-optical disks, ROMs, RAMs, EPROMs, EEPROMs, DRAMs, VRAMs, flash memory devices, magnetic or optical cards, nanosystems (including molecular memory integrated circuits), or any type of media or device suitable for storing instructions and/or data. Memory units may include permanent and/or removable portions of non-transitory computer-readable media (e.g., removable media or external storage, such as an SD card, RAM, etc.).

Information and data may be communicated to and stored in non-transitory computer-readable media of memory 28. Non-transitory computer-readable media associated with memory 28 may also be configured to store logic, code and/or program instructions executable by processor 30 to perform any of the illustrative embodiments described herein. For example, non-transitory computer-readable media associated with memory 28 may be configured to store computer-readable instructions that, when executed by processor 30, cause the processor to perform a method comprising one or more steps. The method performed by processor 30 based on the instructions stored in non-transitory computer readable media of memory 28 may involve processing inputs, such as inputs of data or information stored in the non-transitory computer-readable media of memory 28, inputs received from another device, inputs received from any component of or connected to control system 24. In some embodiments, the non-transitory computer-readable media can be used to store the processing results produced by processor 30.

Processor 30 may include one or more processors and may embody a programmable processor (e.g., a central processing unit (CPU)). Processor 30 may be operatively coupled to memory 28 or another memory device configured to store programs or instructions executable by processor 30 for performing one or more method steps. It is noted that method steps described herein may be embodied by one or more instructions and data stored in memory 28 and that cause the method steps to be carried out when processed by the processor 30.

In some embodiments, processor 30 may include and/or alternatively may be operatively coupled to one or more control modules, such as a calibration module 36 in the illustrative embodiment of FIG. 2, as described further below. Calibration module 36 may be configured to help collect and process information through imaging device 18 and 22, positioning device 32, and sensors 34 during a calibration process. Calibration module 36 may also include algorithms, models, and/or other mathematical expressions that may be read or executed by a computational device (e.g., processor 30). Calibration module 36 and any other module may be implemented in software for execution on processor 30, or may be implemented in hardware and/or software components at least partially included in, or separate from, the processor 30. For example, calibration module 30 may include one or more CPUs, ASICs, DSPs, FPGAs, logic circuitry, etc. configured to implement their respective functions, or may share processing resources in processor 30. As used herein, the term “configured to” should be understood to include hardware configurations, software configurations (e.g., programming), and combinations thereof, including when used in conjunction with or to describe any controller, electronic control unit, or module described herein.

Positioning device 32 may be a device for determining a position of an object. For example, positioning device 32 may be a component configured to operate in a positioning system, such as a global positioning system (GPS), global navigation satellite system (GNSS), Galileo, Beidou, GLONASS, geo-augmented navigation (GAGAN), satellite-based augmentation system (SBAS), real time kinematics (RTK), or another type of system. Positioning device 32 may be a transmitter, receiver, or transceiver. Positioning device 32 may be used to determine a location in two-dimensional or three-dimensional space with respect to a known coordinate system (which may be translated into another coordinate system).

Sensors 34 may include a device for determining changes in posture and/or location of movable object 10. For example sensors 34 may include a gyroscope, a motion sensor, an inertial sensor (e.g., an IMU sensor), an optical or vision-based sensory system, etc. Sensors 34 may include or more sensors of a certain type and/or may include multiple sensors of different types. Sensors 34 may enable the detection of movement in one or more dimensions, including rotational and translational movements. For example, sensors 34 may be configured to detect movement around roll, pitch, and/or yaw axes and/or along one or more axes of translation.

The components of electronic control unit 26 can be arranged in any suitable configuration. For example, one or more of the components of the electronic control unit 26 can be located on movable object 10, carrier 16, payload 14, imaging devices 18 and/or 22, or an additional external device in communication with one or more of the above. In some embodiments, one or more processors or memory devices can be situated at different locations, such as on the movable object 10, carrier 16, payload 14, imaging devices 18 and/or 22, or an additional external device in communication with one or more of the above, or suitable combinations thereof, such that any suitable aspect of the processing and/or memory functions performed by the system can occur at one or more of the aforementioned locations.

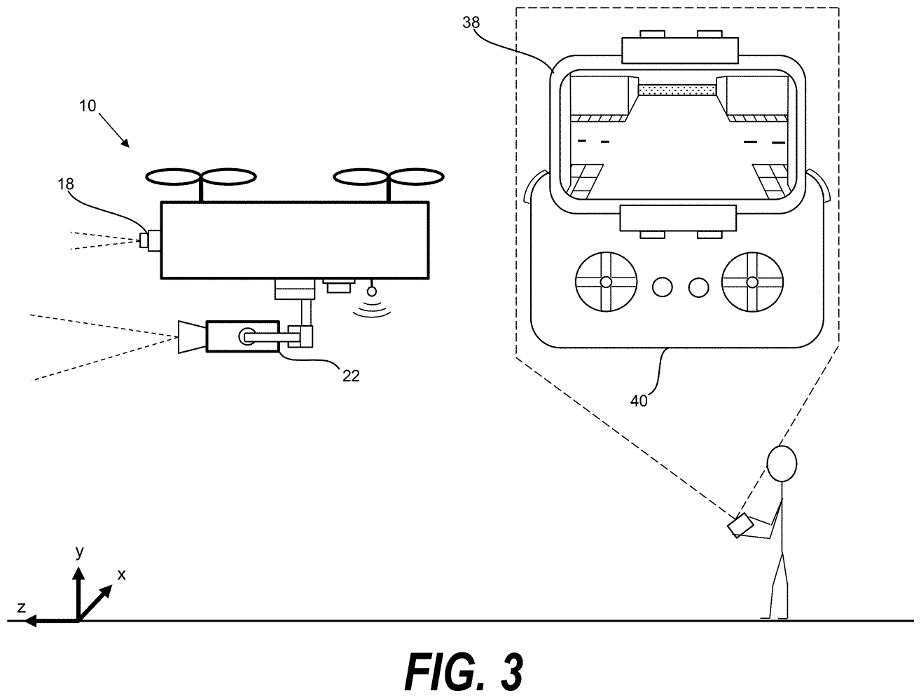

FIG. 3 shows an exemplary embodiment in which movable object 10 is being operated in three-dimensional space (e.g., “real space”). A coordinate system may be defined in real space to provide a frame of reference for understanding and quantifying translational and rotational movements. For example, FIG. 3 shows coordinate axes x, y, and z, which represent an exemplary three-dimensional coordinate system. This coordinate system may be referred to as a “world coordinate system” (WCS) and may have as its origin any desired point in real space. It is contemplated that other coordinate systems may be used.

Imaging devices 18 and/or 22 may be used to capture images in real space, and the images may be displayed, for example, on a display device 38. Display device 38 may be an electronic display device capable of displaying digital images, such as digital images and videos captured by imaging devices 18 and 22. Display device 38 may be, for example, a light emitting diode (LED) screen, liquid crystal display (LCD) screen, a cathode ray tube (CRT), or another type of monitor. In some embodiments, display device 38 may be mounted to a user input device (“input device”) 40 used to operate or control movable object 10. In other embodiments, display device 38 may be a separate device in communication with imaging devices 18 and/or 22 via a wired or wireless connection. In some embodiments, display device 38 may be associated with or connected to a mobile electronic device (e.g., a cellular phone, smart phone, personal digital assistant, etc.), a tablet, a personal computer (PC), or other type of computing device (i.e., a compatible device with sufficient computational capability).

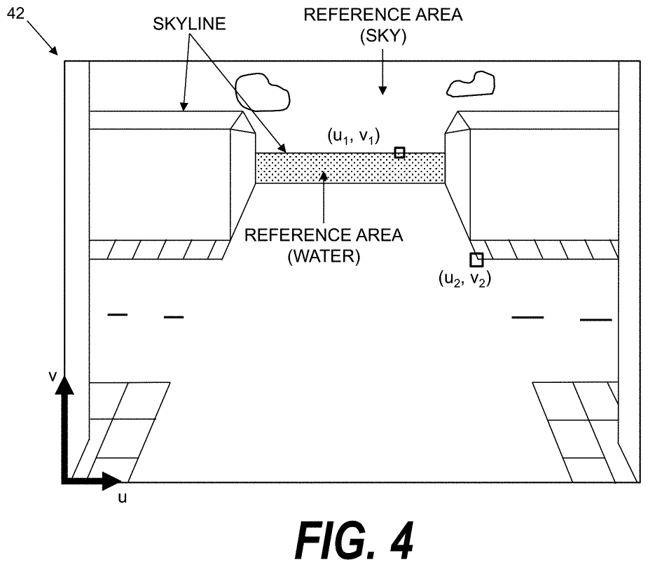

FIG. 4 shows an exemplary image 42 captured by an imaging device, such as one of imaging devices 18 and/or 22. Image 42 may be a digital image comprised of a number of pixels arranged in a two-dimensional matrix. As shown in FIG. 4, a coordinate system may be established for the two-dimensional plane of image 42 to provide a frame of reference for positioning and locating objects and features in the image. For example, FIG. 4 shows coordinate axes u and v, which represent an exemplary two-dimensional coordinate system. This coordinate system may be referred to as an “image coordinate system” (ICS) and may have as its origin any desired point in the two-dimensional plane of the image. For example, the origin of the image coordinate system may be in a corner of the image when the image is rectangular. Using the image coordinate system, a two-dimensional location for every pixel can be established.

Control system 24 may be configured to detect, identify, and/or track features in images captured by imaging devices 18 ad 22. Features in image may refer to physical features of subject matter reflected in the image. For example, features may include lines, curves, corners, edges, interest points, ridges, line intersections, contrasts between colors, shades, object boundaries, blobs, high/low texture and or other characteristics of an image. Features may also include objects, such as any physical object identifiable in an image. Features in an image may be represented by one or more pixels arranged to resemble visible characteristics when viewed. Features may be detected by analyzing pixels using feature detection methods. For example, feature detection may be accomplished using methods or operators such as Gaussian techniques (e.g., Laplacian of Gaussian, Difference of Gaussian, etc.), features from accelerated segment test, determinant of Hessian, Sobel, Shi-Tomasi, and others. Other known methods or operators not listed here may also be used. Such methods and operators may be familiar in the fields of computer vision and machine learning. Detected features may also be identified as particular features or extracted using feature identification techniques. Feature identification or extraction may be accomplished using Hough transform, template matching, blob extraction, thresholding, and/or other known techniques. Such techniques may be familiar in the fields of computer vision and machine learning. Feature tracking may be accomplished using such techniques as Kanade-Lucas-Tomasi (KLT) feature tracker and/or other known tracking techniques.

For example, FIG. 4 shows two feature points or interest points in image 42 located at image coordinate points (u₁, v₁) and (u₂, v₂). In the example of FIG. 4, the interest point at (u₁, v₁) may be a line or feature point near a line. The line may correspond to a skyline, such as the horizon (i.e., the apparent line where the sky meets an area “below” the sky, such as a body of water or land feature). The interest point (u₂, v₂) may be a corner. Lines, corners, blobs, and/or other types of features may be detected in images captured by imaging devices 18 and/or 22. The interest points (u₁, v₁) and (u₂, v₂) are shown for purposes of example and are not intended to be limiting in any way.

The location of coordinate points in the image coordinate system (such as coordinate points (u₁, v₁) and (u₂, v₂) in the example of FIG. 4) can be translated into locations in world coordinate system of real space (i.e., three-dimensional space). Various techniques exist for determining a three-dimensional location based on a two-dimensional location. Some techniques involve comparisons between images taken at different locations (either by multiple imaging devices separated by a distance, or by one camera from multiple different locations). Such techniques use algorithms and/or models to mathematically convert locations in the image coordinate system to locations in the world coordinate system based on the locations of feature points in the image coordinate system and fixed relationships between the image coordinate system and the world coordinate system. These relationships are affected by the posture of imaging devices 18 and/or 22, and therefore the algorithms and models used to convert image coordinate locations to world coordinate locations must be calibrated to the posture of imaging devices 18 and/or 22. The posture of imaging devices 18 and 22 may refer to the roll, pitch, and yaw displacements of imaging devices 18 and 22, as well as their translational displacements in space. Thus, calibration may involve determining a rotational factor, a translational factor, and or other displacement factors (e.g., angular, linear, etc.).

An exemplary model for converting two-dimensional coordinate to three-dimensional coordinates is shown below:

$$[ \begin{matrix}u \\ v \\ 1\end{matrix} ] = K [ R \vert T ] [ \begin{matrix}x \\ y \\ z \\ 1\end{matrix} ] \qquad ( 1 )$$

where u and v are coordinates in the two-dimensional image coordinate system; x, y, and z are coordinates in the three-dimensional world coordinate system; K is a calibration matrix; R is a rotation matrix; and T is a translation matrix.

An exemplary calibration matrix K is shown below:

$$K = [ \begin{matrix}{α}_{x} & γ & {u}_{0} \\ 0 & {α}_{y} & {v}_{0} \\ 0 & 0 & 1\end{matrix} ] \qquad ( 2 )$$

where αₓ is equal to fmₓ (where f is the focal length of an imaging device and mₓ is a scale factor); α_{y} is equal to fm_{y} (where f is the focal length of an imaging device and m_{y} is a scale factor); γ is a distortion parameter; and u₀ and v₀ are coordinates for the optical center point in the image coordinate system. The parameters in calibration matrix K may be known parameters (e.g., known to be associated with an imaging device) or may be determined empirically. The rotation matrix R and translation matrix T may be determined empirically using a calibration process.

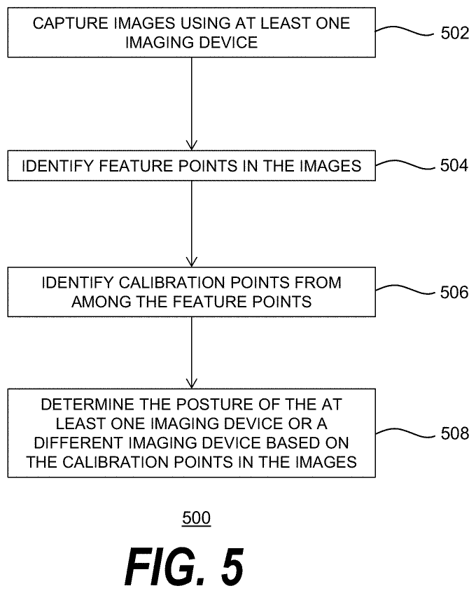

Consistent with embodiments of the present disclosure, calibration of an imaging system may include, for example, determining the relative positions of two cameras in a binocular system (such as imaging devices 18), or between any two cameras. Calibration may also include determining the posture (such as tilt) of a camera with respect to the ground coordinate system or world coordinate system. FIG. 5 is a flow chart of an exemplary process 500 consistent with embodiments of this disclosure that may be used in a process for calibrating an imaging system. Process 500 may be implemented in computer-readable and computer-executable software (e.g., “code”), hardware, and/or combinations thereof. Software implementations of process 500 may be written in any suitable code language or graphical programming environment capable of being executed by or in conjunction with a computer processor, such as a processor component of control system 24 (e.g., processor 30), and may be stored in a suitable memory, such as a memory component of control system 24 (e.g., memory 28), or as part of the processor.

Step 502 may include capturing two or more images of substantially the same view by two separate imaging devices separated by a distance or by a single imaging device from two different points in space. For example, referring to FIG. 1, multiple imaging devices 18 may include a left imaging device and a right imaging device separated by a distance on movable object 10. Alternatively, two images may be captured respectively by one of imaging devices 18 and imaging device 22 or by a single camera. In some embodiments, two or more images are captured using multiple imaging devices simultaneously.

Alternatively, two or more images are captured sequentially by a single imaging device (such as one of imaging devices 18 or imaging device 22) from different locations as movable object 10 moves in space. For example, a first image may be captured using an imaging device with movable object 10 at a first location, and a second image may be captured using the same imaging device with movable object 10 at a different location.

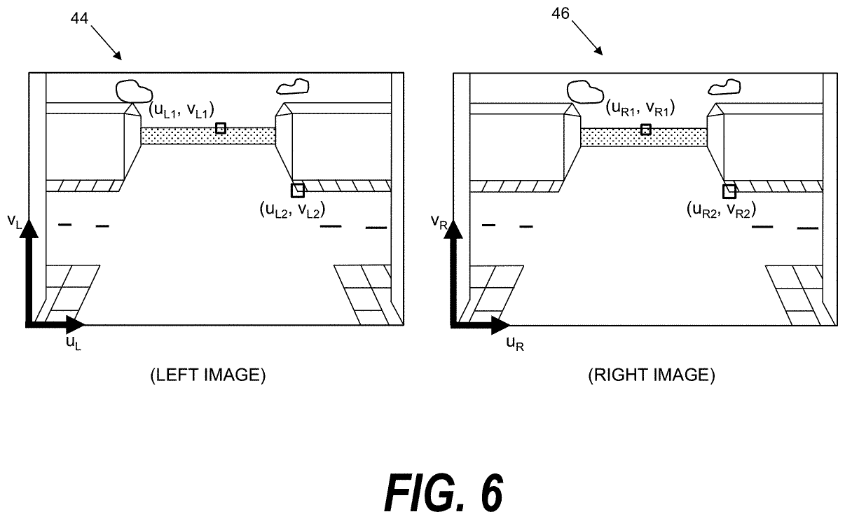

As an example, FIG. 6 shows a left image 44 and a right image 46 captured by the left and right imaging devices of imaging devices 18, respectively. Each image 44 and 46 has an image coordinate system, which may be the same image coordinate system (e.g., as understood by control system 24), differentiated by left and right side designations for purposes of convenience in this description.

Once two or more images are captured, in Step 504, feature points are identified in the captured images. As explained above, feature points may be the points in images at which features are located. Features may include lines, curves, corners, edges, interest points, ridges, line intersections, blobs, and contrasts between colors, shades, object boundaries, high/low texture and or other characteristics of an image. Features may also include or correspond to objects, such as any physical object identifiable in an image. Features in an image may be represented by one or more pixels arranged to resemble visible characteristics when viewed. Features may be detected by analyzing pixels using feature detection methods. For example, feature detection may be accomplished using methods or operators such as Gaussian techniques (e.g., Laplacian of Gaussian, Difference of Gaussian, etc.), features from accelerated segment test, determinant of Hessian, Sobel, Shi-Tomasi, and/or others. Other known methods or operators not listed here may also be used. Such methods and operators may be familiar in the fields of computer vision and machine learning. Detected features may also be identified as particular features or extracted using feature identification techniques. Feature identification or extraction may be accomplished using Hough transform, template matching, blob extraction, thresholding, and/or other known techniques. Such techniques may be familiar in the fields of computer vision and machine learning. Feature tracking may be accomplished using such techniques as Kanade-Lucas-Tomasi (KLT) feature tracker and/or other known tracking techniques, for example, Scale-invariant feature transform (SIFT), Oriented FAST and rotated BRIEF (ORB), or FAST and BRIEF. Features identified in each image may be correlated with the known techniques as well.

Referring again to the example of FIG. 4, a first feature point may be located at coordinate point (u₁, v₁). The exemplary feature point at (u₁, v₁) may be a point identified at or near a skyline, such as where the sky meets a body of water. This is just one type of exemplary feature point that may be detected. Other types of feature points may include skylines defined by the sky and another feature, such as a geological feature (such as the ground, the ridge of a mountain, a hill, etc.), a building top, a road surface, a tree line, a plateau, etc. Feature points may also include other identifiable interest points, such as any object or portion thereof visible in an image, or any other shape, color, or texture characteristic identifiable in the image. For example, a second exemplary feature point shown in FIG. 4 may be located at coordinate point (u₂, v₂). The exemplary feature point at (u₂, v₂) may be a point identified at or near a corner, such as the corner of a sidewalk or curb. Other corners, such as corners of buildings, roof lines, windows, etc., may also be identified. Feature points may also be identified by or in conjunction with identifying reference areas in captured images. For example, using the techniques mentioned above, areas in images may be identified based on color, shade, texture, etc., which may represent certain features. For instance, areas of water (e.g., oceans, lakes, ponds, rivers, etc.), areas of land (e.g., roads, sidewalks, lawns, deserts, beaches, fields, rock beds, the sky, etc.), large objects (e.g., building faces), and/or other features may be identified using pattern recognition or color, shade, texture recognition. Although not shown in FIG. 4, more than two feature points of one or more different types may be identified in captured images.

Step 506 may include identifying calibration points from among the feature points identified in the images. As mentioned above, calibration may be performed to understand the posture of each imaging device. Thus, understanding the rotational and translational (e.g., linear) positions of the imaging devices may be desired. One technique for understanding the rotational and translational positions of an imaging device is to calculate rotational and translational factors based on the two-dimensional locations of features in captured images. Rotational factors may be determined based on identifying feature points with little or no difference in translational location between two images (with respect to the image coordinate system), while translational factors may be determined based on identifying feature points with varying translational locations. In other words, feature points for determining rotational factors may be feature points corresponding to the same feature (i.e., the same physical feature in real space) that appears to be at the same two-dimensional location in the image coordinate system between images. And feature points for determining translational factors may be feature points corresponding to the same feature (i.e., the same physical feature in real space) that appears to be at different two-dimensional locations in the image coordinate system between images.

Two images taken of the same view, either simultaneously by two cameras of a binocular system, or by a single camera from two different locations, provide a stereoptic view. As is commonly known, the same object may appear in different positions in two stereo images. The difference between the locations of the same object or feature in two images is referred to as “disparity,” a term understood in the fields of image processing, computer vision, and machine vision.

Disparity may be minimal (e.g., 0) for feature points that may be referred to as “far points,” i.e., feature points far enough away from an imaging device (such as the skyline) that the features appear not to move between the images. Features with noticeable disparity, i.e., features that appear to move between the images even though they may not have actually moved in real space, may be near enough to the imaging device(s) and are referred to as “near points.” Disparity is inversely related to the distance between the locations at which images are taken (e.g., the distance between two imaging devices or the distance between two points from which images are taken using the same imaging device).

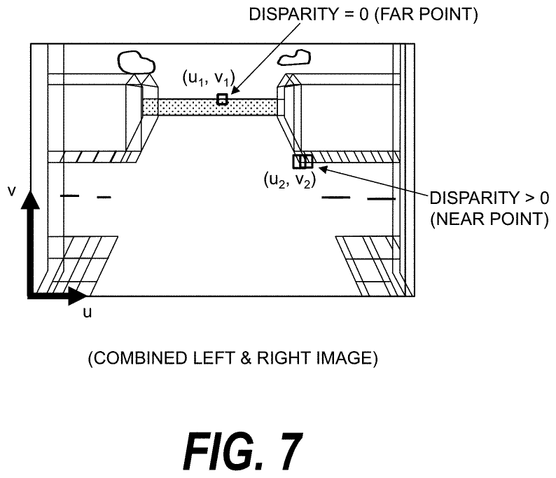

FIG. 7 is an example of a comparison of two images (e.g., the images of FIG. 6) to identify far points and near points. Although only two feature points are shown (e.g., one far point and one near point), it is contemplated that multiple feature points may be identified (though not every feature point in one image must be identified in another image). As shown in FIG. 7, the feature point with disparity of 0 (e.g., where the feature point appears not to have moved from one image to the next) may be identified as a far point. It is contemplated that, due to noise and/or variations in imaging conditions, a disparity other than exactly 0 may be used to identify far points. For example, the disparity for identifying a far point may be within a threshold of 0 or near 0. The term “near 0” may refer to a disparity value that is within a threshold of 0 or is greater than 0 or less than 0 by an amount determined to correspond to an acceptable far point distance. Disparity values may be determined to correspond to an acceptable far point distance based on empirical testing, theoretical calculation, and/or other techniques. As also shown in FIG. 7, the feature point with disparity greater than 0, or greater than a threshold, may be identified as a near point. It is contemplated that “greater than 0” may refer to an absolute value of disparity where disparity may be measured in positive and negative values depending on the direction of displacement between the location of the feature point from one image to another. That is, actual disparity for near points may be greater than 0 or less than 0, depending on the circumstances. Consistent with embodiments of the present disclosure, far points and near points may be used as calibration points, in step 508, determine the posture of the at least one imaging device or different imaging device based on the calibration points in the images, for instance, determine the imaging devices 18 and/or 22. For instance, far points may be used to determine rotational factors of posture, while near points may be used to determine translational factors of posture.

It is possible a non-far point may have a disparity of 0 or near 0 between two images because of the collective rotational and translational displacement between the two images. Feature points identified as potential or candidate far points may be identified based on disparity and confirmed as far points based on subsequent disparity determinations. For instance, where a feature point is identified as a far point based on disparity, subsequent movement of movable object 10 may change the point of view of imaging devices 18 and/or 22 such that the disparity of the identified feature point may be greater than 0 (or beyond a threshold) in a subsequent comparison and disparity determination. In such a case, the candidate feature point may not be an actual far point and may be discarded for purposes of calibration and determining posture. Thus, consistent with embodiments of the present disclosure, more than two images may be captured in Step 502, and disparity calculated for the feature points between the multiple images, to improve accuracy of identification of far points. If the disparity of a candidate far point does not change (or does not change substantially) over time, there is a higher probability that the candidate far point is a true far point that can be used for calibration and posture determination.

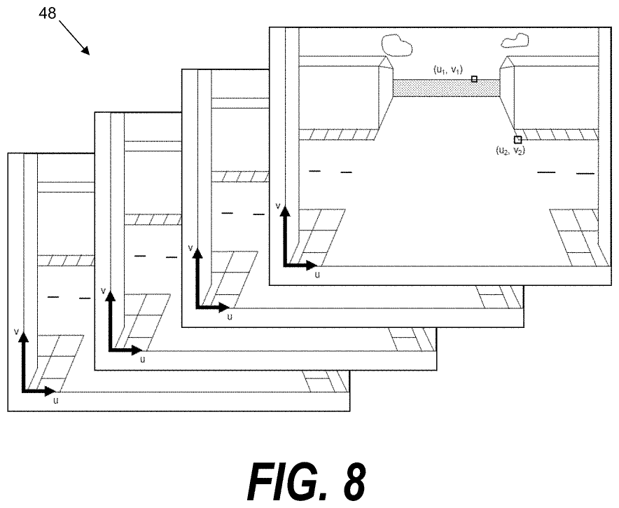

As discussed above, the multiple images may be obtained by imaging devices as over a period of time as movable object 10 moves. As shown in FIG. 8, multiple images 48 are captured over time, and the disparity of each feature point between images 48 is calculated to identify whether the feature point is a far point. Although four images are shown in FIG. 8 for exemplary purposes, it is contemplated that fewer or more images may be captured in the second set 48. The feature points identified as candidate far points may be tracked using known feature tracking techniques, such as the Kanade-Lucas-Tomasi (KLT) feature tracker. By tracking the candidate far points and determining their disparity across more than two images, feature points with suitable disparity values may be identified as far points, while other feature points may be discarded or ignored. It is to be understood that the multiple images may comprise images sequentially captured by a single camera, multiple sets of images simultaneously captured by two cameras (such as a binocular system).

Consistent with embodiments of the present disclosure, identification of calibration points (Step 506) may include further analysis of the feature points identified as far points based on comparison of the images. In particular, a calculation may be performed to determine the real space distance of the feature point from the imaging device, and if the distance is greater than a threshold, the feature point is deemed a far point.

To determine the distance from a feature point to an imaging device in the system, the two-dimensional image coordinates of a feature points can be converted to the three-dimensional world coordinate system, which allows the unknown distance to be determined. The position of a feature point in the world coordinate system may be represented by the term P^{w}, which may be determined using the following expression:

$${min}_{{P}^{w}} ( {[ {\sum }_{i = 1}^{n} ( ( \begin{matrix}{u}_{i} \\ {v}_{i} \\ 1\end{matrix} ) - h ( K ( {R}_{i} {P}^{w} + {T}_{i} ) ) ) ]}^{2} ) \qquad ( 3 )$$

The operation or calculation in expression (3) is performed on feature points across multiple images. The number of images may be represented by the term n.

$$( \begin{matrix}{u}_{i} \\ {v}_{i}\end{matrix} )$$

represents the two-dimensional coordinates of a feature point in the i-th image. Ri and Ti represent the rotational matrix and translational matrix for the i^{th} image. The rotational matrix Ri may be determined based on rotational information collected by a sensor capable of measuring rotational parameters, such a sensor 34 (e.g., an IMU sensor, gyroscope, or other type of sensor). The translational matrix Ti may be determined using a sensor or system capable of determining a change in translational or linear position, such as positioning device 32 (e.g., GPS or other type of system). The parameters in calibration matrix K (in expression (2)) may be known parameters (e.g., known to be associated with an imaging device) or may be determined empirically. The projection matrix h operates on a 3-D point

$$[ \begin{matrix}x \\ y \\ z\end{matrix} ]$$

as follows:

$$h ( [ \begin{matrix}x \\ y \\ z\end{matrix} ] ) = z [ \begin{matrix}x / z \\ y / z \\ 1\end{matrix} ] = z [ \begin{matrix}{x}^{′} \\ {y}^{′} \\ 1\end{matrix} ] \qquad ( 4 )$$

where

$$[ \begin{matrix}x \\ y \\ 1\end{matrix} ]$$

is the three-dimensional coordinates of a point in space and

$$[ \begin{matrix}{x}^{′} \\ {y}^{′} \\ 1\end{matrix} ]$$

is the projected two-dimensional location, or homogeneous coordinates, of that 3-D point on an image, where

$$[ \begin{matrix}{x}^{′} \\ {y}^{′}\end{matrix} ]$$

represents the two dimensional coordinates from the perspective of the imaging device.

P^{w} is the coordinate value of each feature point identified in the first image of the multiple images n, wherein the value includes three dimensions, one of them being the distance between the imaging device and the position of the interest points (e.g., the distance in real space). By solving the minimum P^{w} value that satisfies the expressions above, the distance from an imaging device to each feature point can be determined, which can help determine whether a feature point is a suitable calibration point. For example, the coordinate dimension corresponding to the distance from the feature point to the imaging device in P^{w} can be compared to predetermined threshold values for identifying far points and near points. For instance, the distance value in in P^{w} can be compared to a first threshold value, and if the distance value is greater than or equal to the first threshold value, the feature point corresponding to P^{w} may be a suitable far point. The distance value in P^{w} can also be compared to a second threshold (which may be the same or different from the first threshold), and if the distance value is less than the second threshold, the feature point corresponding to P^{w} may be a suitable near point. The threshold values may be determined empirically or theoretically. That is, the threshold comparisons may help determine in a physical sense whether the candidate near points and candidate far points are actually physically far enough away from the imaging devices to constitute valid feature points for calibrating the imaging system.

With suitable far points and near points selected using the methods described above, rotation and translation matrices (i.e., calibrated matrices) may be determined to reflect the current posture of and relationship between two cameras (such as in a binocular system or between two cameras mounted on movable object 10. As noted above, the identified far points may be calibration points for determining the rotation matrix, and the identified near points may be calibration points for determining the translation matrix. To determine the rotation and translation matrices, a set of images may be captured (e.g., at least a pair of images taken in accordance with the methods described above) that include the calibration points identified (e.g., the near point(s) and far point(s) identified in accordance with the methods described above). Images captured in Step 502 may be used for this purpose as well. For a set of calibration points (e.g., numbered 1 through n for convenience), the location of the calibration points in the two-dimensional image coordinate system in each image in a pair of images can be used to determine a rotation matrix R or a translation matrix T.

For example, a rotation matrix R characterizing the relative rotational displacement between the left and right imaging devices 18 may be determined using the following expression:

$${min}_{R} ( {\sum }_{i = 1}^{n} {{K}_{l}^{- 1} ( u {l}_{i} , {vl}_{i} , 1 )}^{T} - R \cdot {{K}_{r}^{- 1} ( u {r}_{i} , {vr}_{i} , 1 )}^{T} ) \qquad ( 5 )$$

where ulᵢ represents the u coordinate of the i^{th} calibration point in a left image captured by the left imaging device; vlᵢ represents the v coordinate of the i^{th} calibration point in the left image; urᵢ represents the u coordinate of the i^{th} calibration point in a right image captured by the right imaging device; and vrᵢ represents the v coordinate of the i^{th} calibration point in the right image. Kₗ and Kᵣ represent the calibration matrices of the left and right imaging devices, respectively (and may be the same where the same imaging device was used to capture both images). By solving the minimum R value that satisfies the expressions above, a matrix can be determined that accounts for the relative rotational posture of the left and imaging devices.

Likewise, a translation matrix T characterizing the relative translational displacement between the left and right imaging devices 18 may be determined using the following expression:

$${min}_{T} ( {\sum }_{i = 1}^{n} {{Kl}^{- 1} ( u {l}_{i} , {vl}_{i} , 1 )}^{T} \cdot skew ( T ) \cdot R \cdot {{Kr}^{- 1} ( u {r}_{i} , {vr}_{i} , 1 )}^{T} ) \qquad ( 6 )$$

In Expression (6), R be the rotational matrix determined through Expression (5) above, or may be determined based on data collected from sensors capable of identifying rotational displacements, such as sensor 34. By solving the minimum T value that satisfies the expressions above, a matrix can be determined that accounts for the translational posture of the left and right imaging devices.

In a multi-camera system, the above method may be applied to determine the relative positions (both rotational and translational) between any two cameras, using images captured by the two cameras simultaneously or when the cameras are not in motion.

In some embodiments, an angular displacement, e.g., tilt, of an imaging device can be determined by identifying a line in a captured image and comparing the identified line to a reference line. For example, sometimes an imaging device can become angularly displaced or tilted with respect to a scene to be captured, which may be the result of misalignment of the imaging device on the movable object. To correct for such tilt, the angle of tilt can be determined by comparing a line in a tilted image with a reference line so the image can be processed to account for the tilt. For example, an image can be captured using an imaging device in a manner described above. In some embodiments, an image gathered in a step of process 500 may be used, and in other embodiments, a separate image may be captured. Feature points may then be identified in the image using a known technique in the manner described above, such as Gaussian techniques (e.g., Laplacian of Gaussian, Difference of Gaussian, etc.), features from accelerated segment test, determinant of Hessian, Sobel operator, Shi-Tomasi, and/or others. Feature points identified in steps of process 500 may be used, or alternatively feature points may be identified in a separate process. Feature points of interest for this operation may be feature points on or near line-like features visible in the image. That is, for purposes of comparing to a reference line, features of interest may be sky lines, the horizon, or other types of line-like that can be discerned from an image and may be approximately horizontal with respect to the world coordinate system.

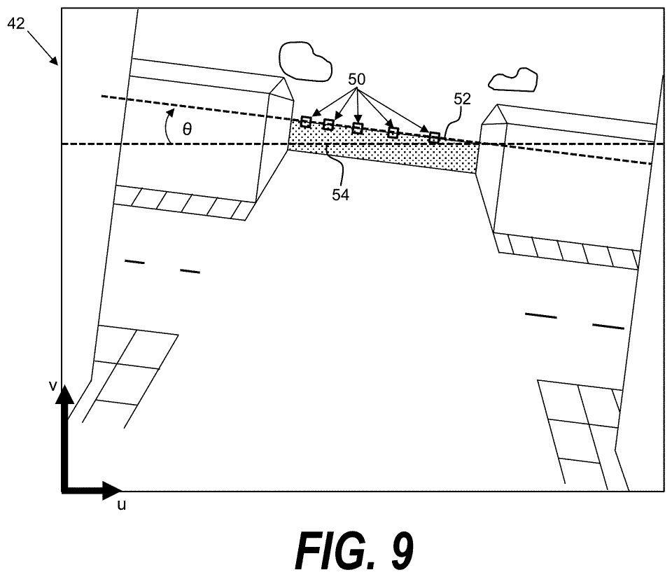

For example, as shown in FIG. 9, feature points 50 on or near sky lines or the horizon may be identified using techniques described above and/or other known techniques. Reference areas, such as the sky, bodies of water, and/or other area features described above may also be identified to help locate and identify line-like features in the images (e.g., where the reference areas appear to meet other objects in the image). Thus, scenes including natural sky lines, such as the horizon, may be used to perform this operation. Other sky lines may also or alternatively be used. Furthermore, any identifiable line-like feature in an image that can be presumed to be or is approximately horizontal (e.g., a top edge of a building) may be identified and feature points on or near such a line-like feature identified for purposes of this operation.

Multiple feature points 50 may be identified on or near the line-like feature. A straight line 52 may be fit to the identified feature points using a suitable technique. For example, the method of least square or random sample consensus (RANSAC) method may be used to fit a line to the identified feature points. The fit line 52 may represent or correspond to the sky line, horizon, or other discernable feature in the image. A reference line 54 may also be identified in the image. In some embodiments, the reference line 54 may be defined with respect to fan axis of the image coordinate system (e.g., the line 54 may be parallel to an axis of the image coordinate system). An angular offset θ between the fit line 52 and the reference line 54 may be determined using the following expression:

$$θ = {tan}^{- 1} \frac{Δ v}{Δ u} \qquad ( 7 )$$

where Δv is a displacement along the v axis of the image coordinate system between the fit line 52 and the reference line 54, and Δu is a displacement along the u axis of the image coordinate system from the intersection of the fit line 52 and the reference line 54. The angle θ may be indicative of an angular displacement of an imaging device with respect to “horizontal” in the world coordinate system when the line 52 is presumed to be horizontal (or an acceptable approximation of horizontal) in the world coordinate system.

It is contemplated that the exemplary comparisons described in the disclosed embodiments may be performed in equivalent ways, such as for example replacing “greater than or equal to” comparisons with “greater than,” or vice versa, depending on the predetermined threshold values being used. Further, it will also be understood that the exemplary threshold values in the disclosed embodiments may be modified, for example, replacing any of the exemplary zero or 0 value with other reference values, such as reference values, threshold values, or comparisons.

It will be further apparent to those skilled in the art that various other modifications and variations can be made to the disclosed methods and systems. Other embodiments will be apparent to those skilled in the art from consideration of the specification and practice of the disclosed methods and systems. For example, while the disclosed embodiments are described with reference to an exemplary movable object 10, those skilled in the art will appreciate the disclosure may be applicable to any movable objects. It is intended that the specification and examples be considered as exemplary only, with a true scope being indicated by the following claims and their equivalents

What is claimed is:

1. A method of calibrating an imaging system, comprising:
capturing images using at least one imaging device;
identifying feature points in the images;
identifying calibration points from among the feature points; and
determining a posture of the at least one imaging device or a different imaging device based on positions of the calibration points in the images.

2. The method of claim 1, wherein the at least one imaging device includes a pair of imaging devices attached to a movable object.

3. The method of claim 1, wherein:
the at least one imaging device includes two imaging devices separated by a distance; and
the images are captured simultaneously.

4. The method of claim 1, wherein the images are captured sequentially at different locations.

5. The method of claim 1, further comprising:
identifying a reference area in the images; and
identifying the feature points at locations within a predetermined distance from the reference area.

6. The method of claim 5, wherein the reference area corresponds to the sky and/or water.

7. The method of claim 1, further comprising:
determining a disparity of corresponding feature points between at least two of the images; and
identifying at least one of the feature points as a calibration point based on the disparity of the corresponding feature points.

8. The method of claim 7, wherein identifying the calibration points comprises identifying a feature point as a calibration point when the disparity of the corresponding feature points is within a threshold.

9. The method of claim 7, wherein identifying the calibration points comprises identifying a feature point as a calibration point when the disparity of the corresponding feature points is 0.

10. The method of claim 7, further comprising:
subsequently capturing additional images using the at least one imaging device;
identifying the feature points in each of the additional images;
determining a disparity of corresponding feature points between images in the additional images; and
identifying at least one feature point as a calibration point based further on the disparity determined in the additional images.

11. The method of claim 10, wherein identifying the calibration points comprises identifying a feature point as a calibration point when the disparity of the corresponding feature points determined in the additional images is within a threshold.

12. The method of claim 10, wherein identifying the calibration points comprises identifying a feature point as a calibration point when the disparity of the corresponding feature points in the additional images is 0.

13. The method of claim 1, wherein identifying the calibration points from among the feature points includes identifying a calibration point based on a three dimensional location of a feature point.

14. The method of claim 1, wherein identifying the calibration points from among the feature points includes identifying the calibration points based on distances of the feature points from the at least one imaging device.

15. The method of claim 1, wherein the calibration points include:
at least one feature point located at a distance from the at least one imaging device that is greater than a first threshold distance in three-dimensional space; and
at least one feature point located at a distance from the at least one imaging device that is less than or equal to a second threshold distance in three-dimensional space.

16. The method of claim 1, wherein:
the posture of the at least one imaging device or the different imaging device includes a rotational component; and
determining the posture of the at least one imaging device or the different imaging device includes determining the rotational component of the posture based on a location of a calibration point greater than a threshold distance from the at least one imaging device.

17. The method of claim 1, wherein:
the posture of the at least one imaging device or the different imaging device includes a translational component; and
determining the posture of the at least one imaging device or the different imaging device includes determining the translational component of the posture based on a location of a calibration point less than a threshold distance from the at least one imaging device.

18. The method of claim 1, wherein the position of each calibration point in the images is a two-dimensional position.

19. The method of claim 1, further comprising:
identifying a line based on the feature points identified in at least one image of the images; and
calculating an angular displacement of the identified line with respect to a reference line associated with the at least one image.

20. The method of claim 19, further comprising:
identifying a first reference area in the at least one image, the first reference area corresponding to the sky;
identifying a second reference area in the at least one image, the second reference area being separated from the first reference area by the identified line and corresponding to a body of water, a flat area of land, or an upper boundary of elevated terrain; and
determining whether the identified line is a horizontal line based on the identifications of the first and second reference areas.
